(19) United States
(12) Patent Application Publication
(10) Pub. No.: US 2013/0224717 A1
(43) Pub. Date: Aug. 29, 2013

(54) COMPUTERIZED LEARNING METHODS AND SYSTEMS FOR USE IN GROUP-LEARNING SETTINGS

(71) Applicant: Signum International S.a.r.I. Luxembourg, Luzern Branch, (US)

(72) Inventors: Madeleine Thun, Bromma (SE); Christopher McCormick, Walchwil (CH); David William Bish, Adlsiwil (CH); Dmitry Makarenko, London (GB); Pedro David Cardoso Gomes, London (GB)

(73) Assignee: Signum International S.a.r.I. Luxembourg Luzrn Branch, Luzern (CH)

(21) Appl. No.: 13/737,591

(22) Filed: Jan. 9, 2013

Related U.S. Application Data
(60) Provisional application No. 61/584,466, filed on Jan. 9, 2012.

(51) Int. Cl. G09B 5/00

(52) U.S. Cl. CPC G09B 5/00
USPC 434/350

(57) ABSTRACT

A computer-implemented method enables guides to distribute learning items to a plurality of participants in a group learning setting in a controlled manner and to guide the participants through learning activities associated with the learning items. The guides and participants operate network-connected computing devices. The method includes the steps of: (a) providing a structured collection of learning items arranged in a given order on a computing device operated by a guide, each learning item being associated with a learning activity to be performed on computing devices operated by the participants; and (b) electronically distributing learning items in the structured collection to computing devices operated by the participants successively in the given order based on instructions received from the guide.

### CROSS REFERENCE TO RELATED APPLICATION

This application claims priority from U.S. Provisional Patent Application No. 61/584,466 filed on Jan. 9, 2012 entitled COMPUTERIZED LEARNING SYSTEM FOR USE IN CLASSROOMS, which is hereby incorporated by reference.

### BACKGROUND

The present application relates generally to computerized education tools and, more specifically, to an online learning system that is particularly suited for use in a classroom setting, allowing teachers to guide students through a variety of learning activities on portable computing devices in a classroom setting.

### BRIEF SUMMARY OF THE DISCLOSURE

A computer-implemented method in accordance with one or more embodiments enables guides to distribute learning items to a plurality of participants in a group-learning setting in a controlled manner and to guide the participants through learning activities associated with the learning items. The guides and participants operate network-connected computing devices. The method includes the steps of (a) providing a structured collection of learning items arranged in a given order on a computing device operated by a guide, each learning item being associated with a learning activity to be performed on computing devices operated by the participants; and (b) electronically distributing learning items in the structured collection to computing devices operated by the participants successively in the given order based on instructions received from the guide.

A computing device In accordance with one or more embodiments comprises at least one processor, memory associated with the at least one processor, a display, and a program supported in the memory. The program enables a guide to distribute learning items to a plurality of participants in a group learning setting in a controlled manner and to guide the participants through learning activities associated with the learning items. The program has a plurality of instructions stored therein which, when executed by the at least one processor, cause the at least one processor to: (a) provide a structured collection of learning items arranged in a given order based on input from the guide, each learning item being associated with a learning activity to be performed on computing devices operated by the participants, and (b) electronically distribute learning items in the structured collection to computing devices operated by the participants successively in the given order based on instructions received from the guide.

A computer program product in accordance with one or more embodiments enables a guide to distribute learning items to a plurality of participants in a group learning setting in a controlled manner and to guide the participants through learning activities associated with the learning items. The computer program product resides on a non-transitory computer readable medium having a plurality of instructions stored thereon which, when executed by a computer processor, cause that computer processor to: (a) provide a structured collection of learning items arranged in a given order based on input from the guide, each learning item being associated with a learning activity to be performed on computing devices operated by the participants, and (b) electronically distribute learning items in the structured collection to computing devices operated by the participants successively in the given order based on instructions received from the guide.

### BRIEF DESCRIPTION OF THE DRAWINGS

FIGS. 1A and 1B are simplified diagrams illustrating the physical network setup and connection between components of exemplary learning systems in accordance with one or more embodiments.

FIGS. 2A and 2B are simplified diagrams illustrating exemplary user flows for teachers and students during a lesson in accordance with one or more embodiments.

FIG. 3 is a simplified diagram illustrating playlist behavior for a teacher and students in an exemplary lesson in accordance with one or more embodiments.

FIGS. 4A to 4H show a series of exemplary screenshots illustrating construction of a playlist in accordance with one or more embodiments.

FIGS. 5A to 5F show a series of exemplary screenshots illustrating construction of another playlist in accordance with one or more embodiments.

FIG. 6 shows an exemplary screenshot showing a classroom buzzer feature in accordance with one or more embodiments.

FIGS. 7A to 7D show a series of exemplary screenshots illustrating construction of another playlist in accordance with one or more embodiments.

### DETAILED DESCRIPTION

Various embodiments disclosed herein are directed to a computerized learning system featuring network-connected portable computing devices used by guides and participants in a group-learning setting. In the various examples illustrated below, the guides comprise teachers, the participants comprise students, and the group learning setting comprises a classroom setting. It should be understood, however, that a variety of other uses are also possible including, e.g., at conferences, meetings, and other gatherings where the guide is a presenter who distributes learning items to members of an audience. The system allows guides to organize and distribute multimedia learning content and tools to participants in a controlled manner, and to guide participants through a variety of learning activities associated with the learning content.

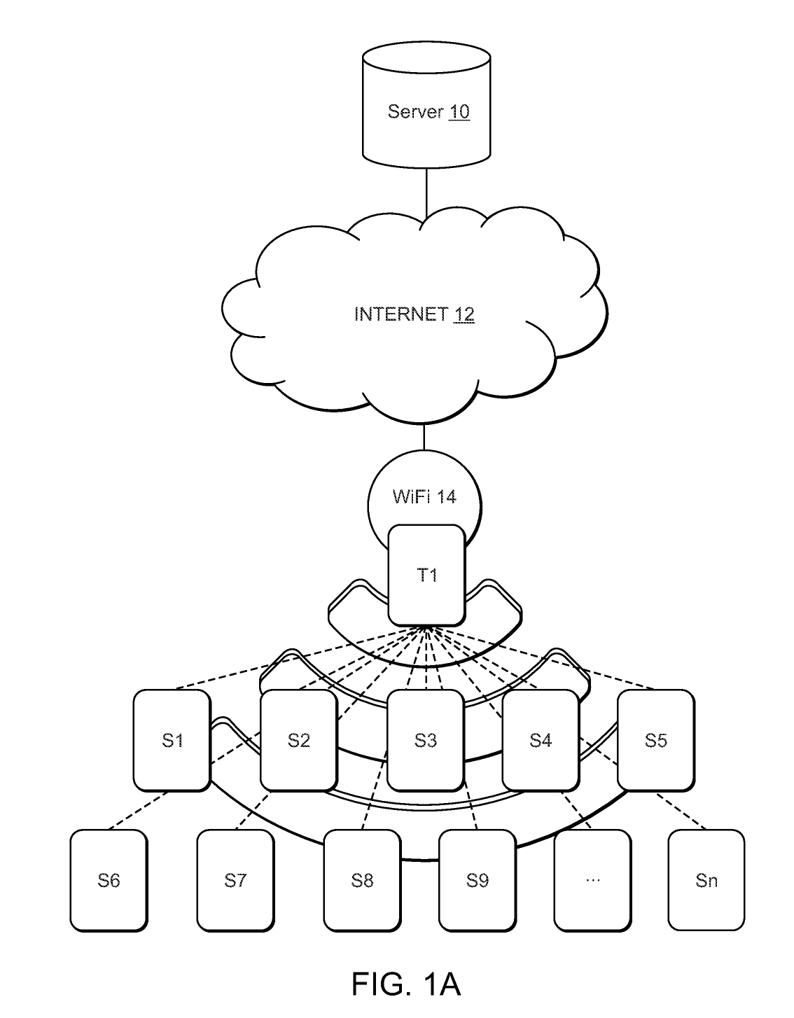

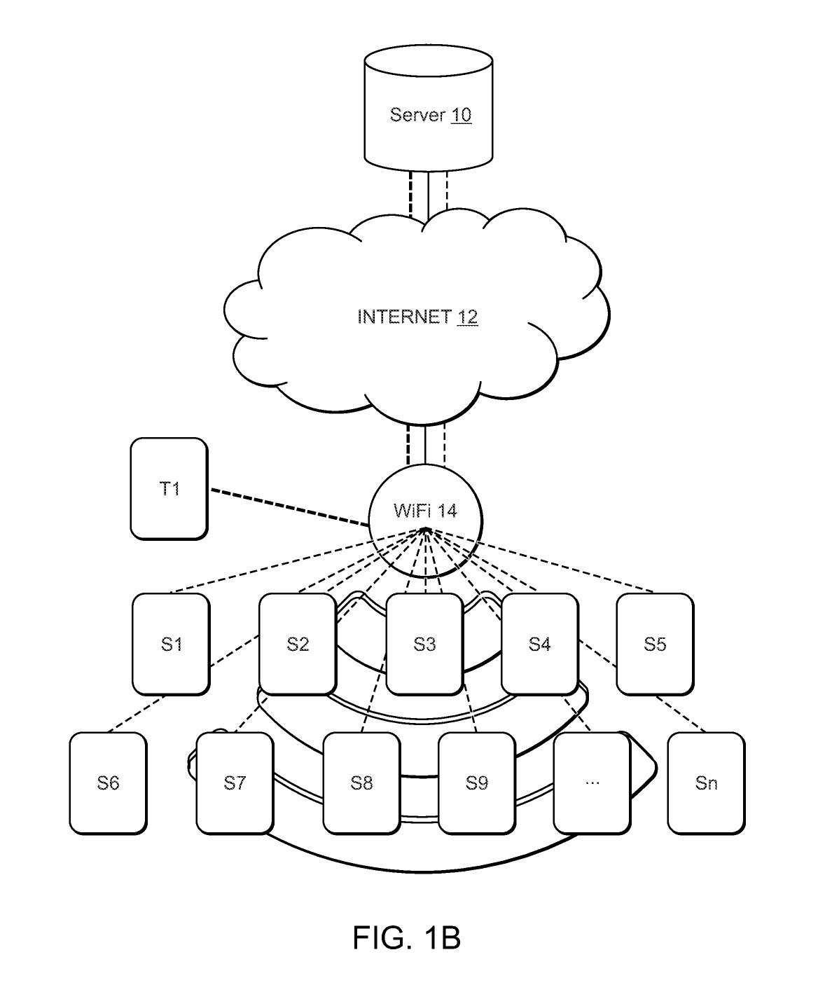

FIGS. 1A and 1B illustrate an exemplary learning system implemented in a classroom setting in accordance with one or more embodiments. The learning system includes a server solution 10 for storage of data. The server 10 can provide account authentication and access to and storage of user specific data, playlists, and learning material. The Internet 12 is used as the interlinking network between the server 10 and a WiFi (or other local) network 14 in the school. The Internet can also be a source of media content such as YouTube videos, Flickr images, articles, etc.

The learning system also includes a teacher computing device T1 and a plurality of student computing devices S1 . . . Sn for each classroom setting.

The teacher and student computing devices preferably comprise tablet computers such as, e.g., the iPad tablet from Apple and Android-based tablet computers, among others. Other types of computing devices can also be used including, without limitation, desktop computers, notebook computers, personal digital assistants, smart phones, and smart tables. Tablet computers offer several advantages over desktop or notebook computers for use in the learning system. For example, they allow users to interface with the computer by writing on or tapping a touchscreen display, obviating the need for separate peripherals like keyboards and pointing devices. Tablet computers are also compact and highly portable, allowing them to be easily shared among users. An application or ‘app’ can be downloaded on the user devices allowing access to the learning system.

FIGS. 1A and 1B depict how the teacher and student devices are connected in the classroom and how interactions between devices are handled. In FIG. 1B, the communication between the devices is handled via a messaging system, with producers and consumers of messages flowing via a server side broker tool. Lessons are started by the teacher device, which generates messages that the student devices can subscribe to and receive.

If Internet connectivity is unavailable but there is a working WiFi network, the system can fall back to a local solution as shown in FIG. 1A using, e.g., Bonjour Service to broadcast the lesson. The IP address of each device is resolved, and the teacher device thereafter sends content directly to the connected student devices without any server solution monitoring the lesson. The lesson is self-contained in the internal network built up by the devices.

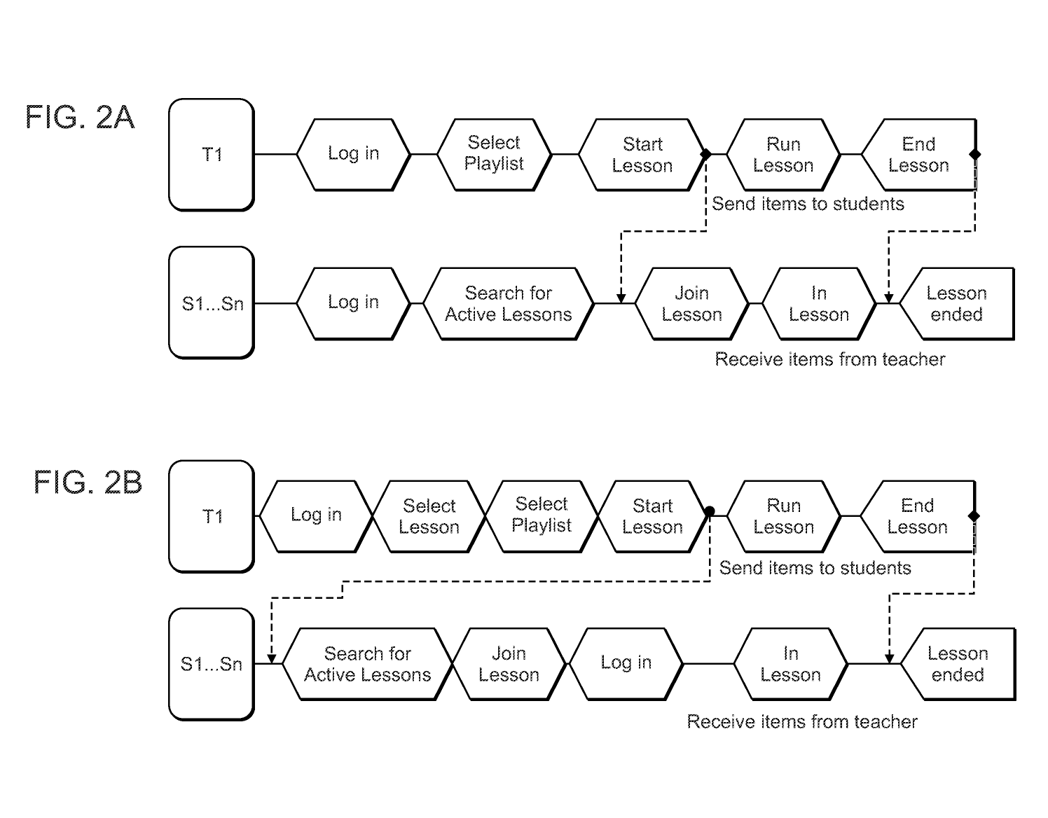

FIGS. 2A and 2B illustrate exemplary user flows for teachers and students during a lesson. The teacher initially signs in to the application. By his or her credentials, he or she is identified as a teacher and is assigned teacher privileges. The teacher then selects a Model Playlist pre-prepared, e.g., by a central Academic Team, selects one of his or her own playlists, or starts a new playlist. As the teacher chooses to start a lesson, the teacher computing device starts a lesson broadcast and acts now as an HTTP server that the students can connect to. Students searching for active lessons will now see the lesson started by the teacher.

Each lesson holds one teacher and many students. Multiple lessons can be conducted at the same time in the building, and the students therefore generally need to choose which lesson to join. By joining the lesson, the student computing device is now connected to the teacher (server) computing device and will receive all Playlist items the teacher sends. The lesson broadcast is ongoing until the teacher chooses to end the lesson. Once the lesson has been ended, no new students can join the lesson.

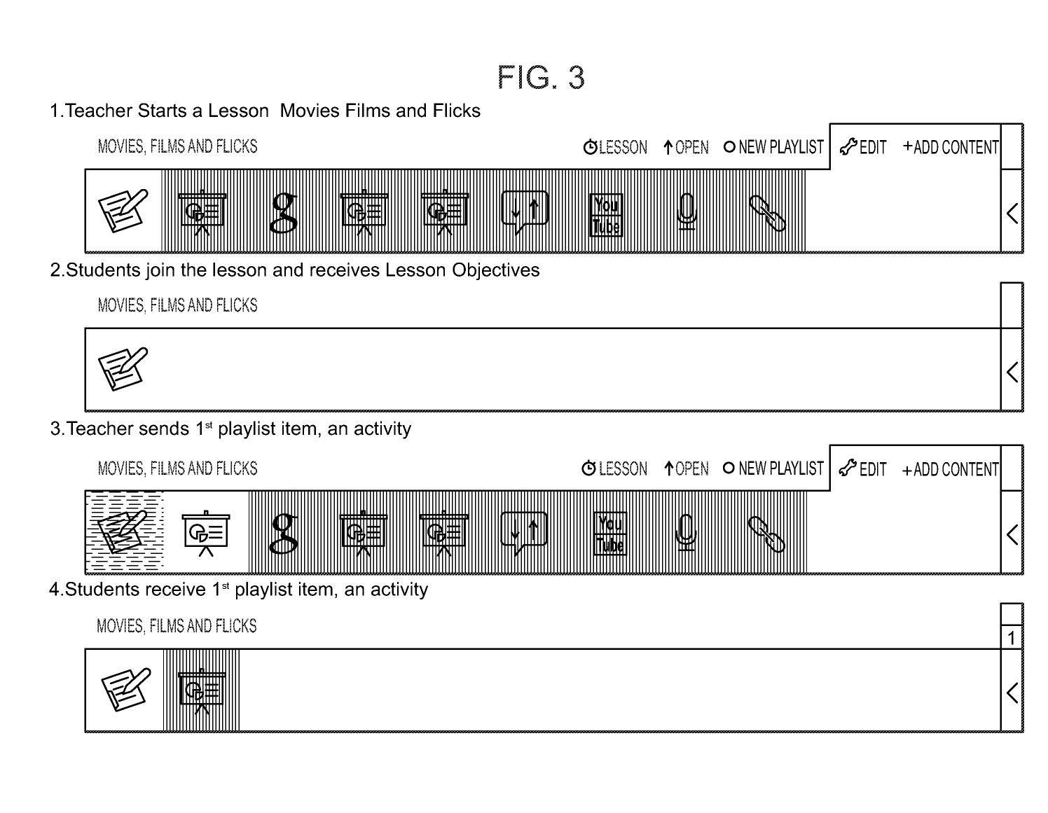

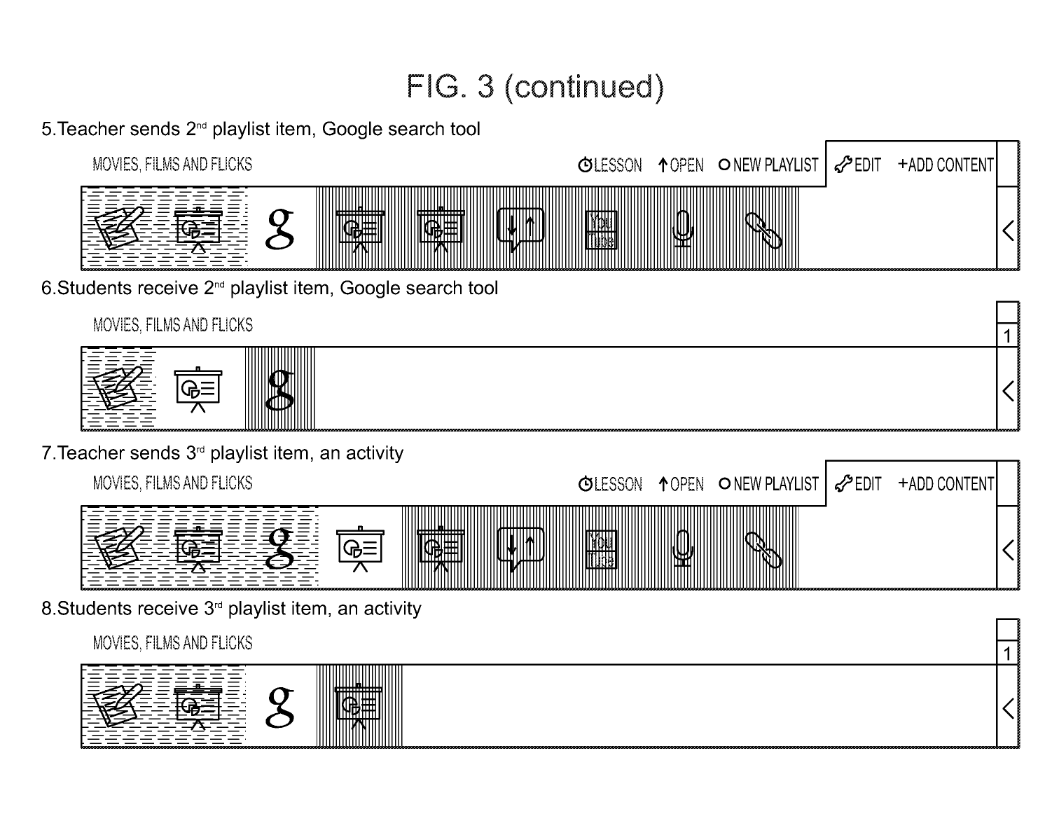

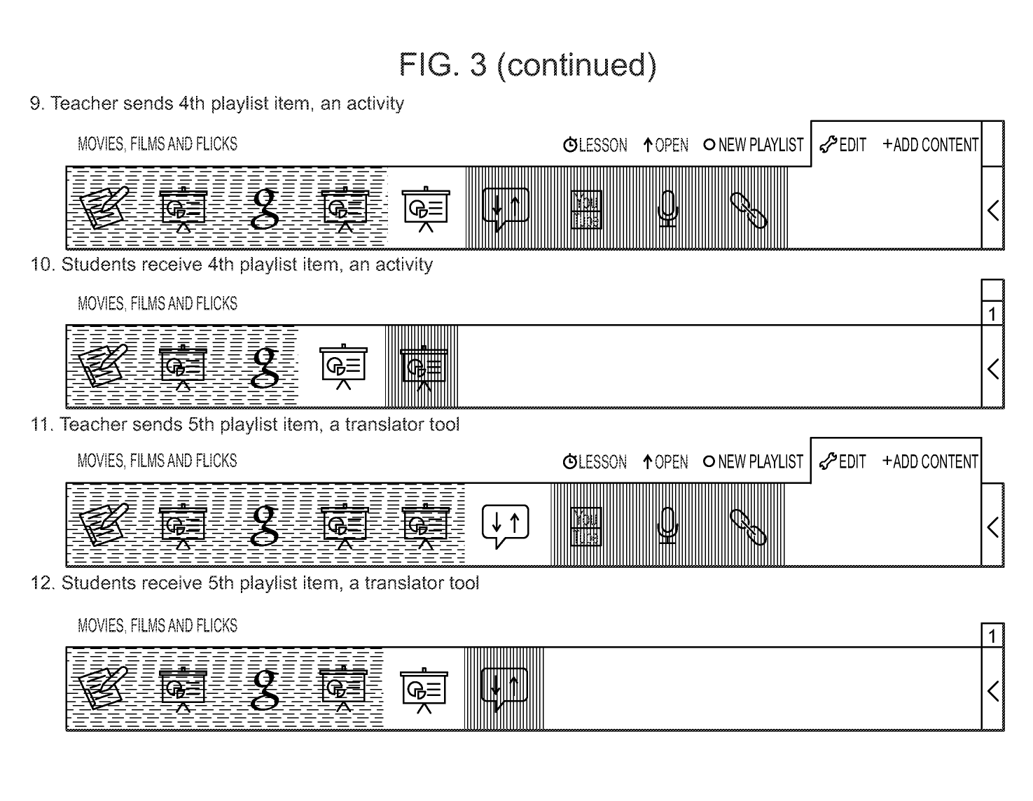

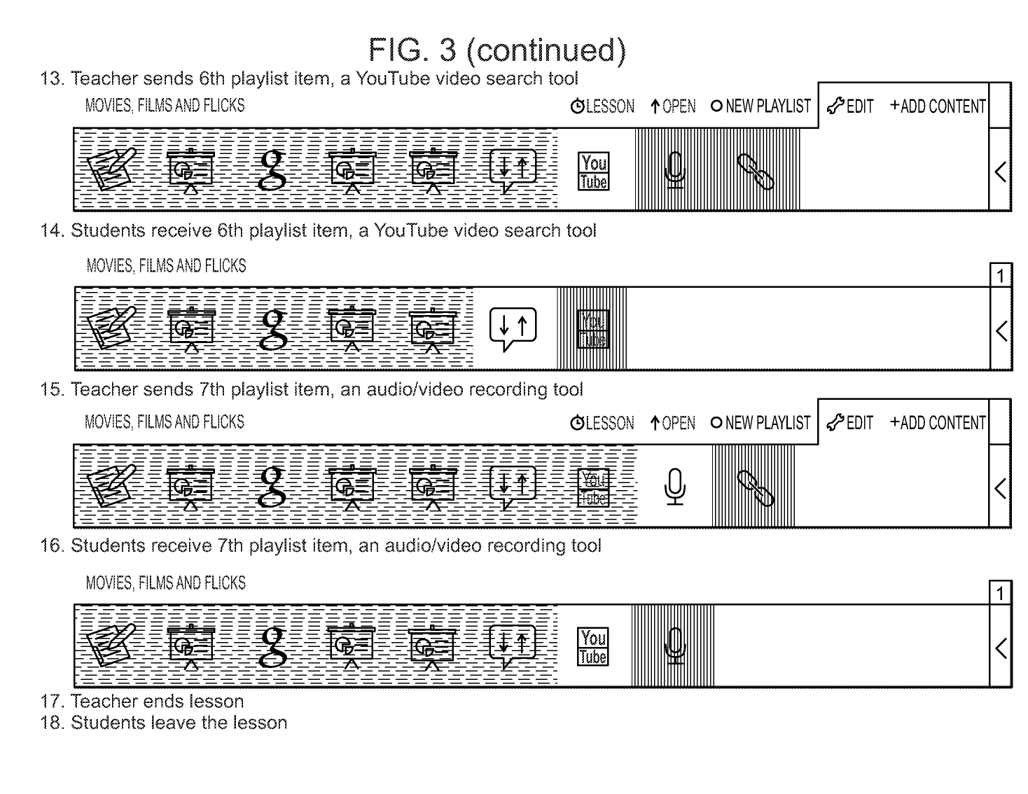

As FIG. 3 illustrates, once the teacher has started the lesson, he or she controls the lesson through the playlist. Students only see what the teacher has sent them. When the students join the lesson and the teacher has not yet sent any items, their playlist drawer is empty except for the Lesson Objectives. As the teacher conducts the lesson, he or she sends items one by one out to the students, and the students receive them in the order they have been sent. The playlist items change state to show what action has been performed on them as shown in FIG. 3. These states are slightly different for teachers and students.

Teacher states:
Red=Item not yet sent to students
White=Item currently being viewed by the teacher
Grey=Item sent to students

Student states:
Red=Item not yet viewed
White=Item currently being viewed by the student
Grey=Item viewed

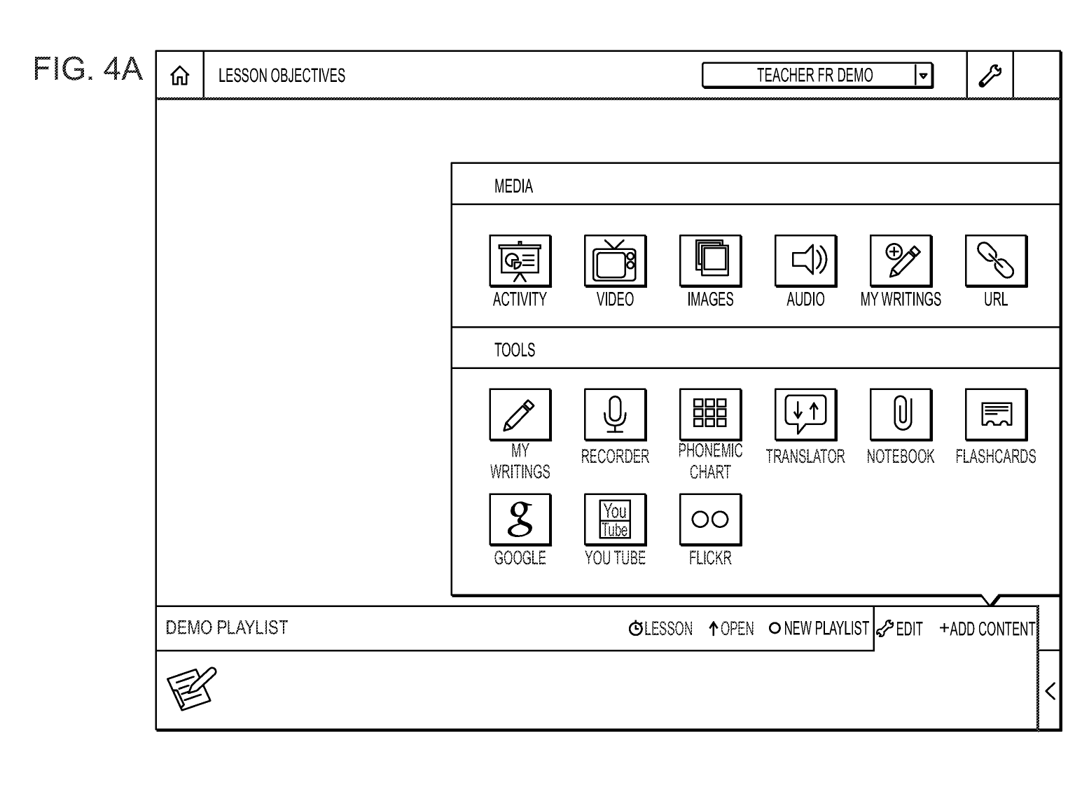

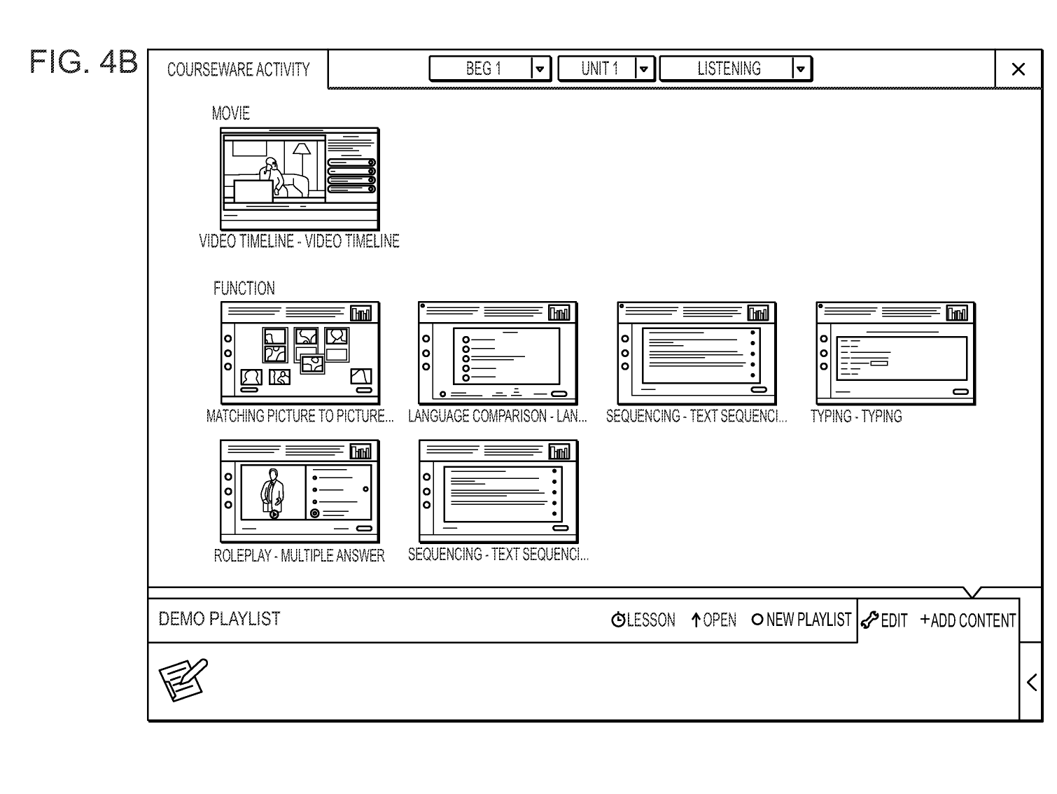

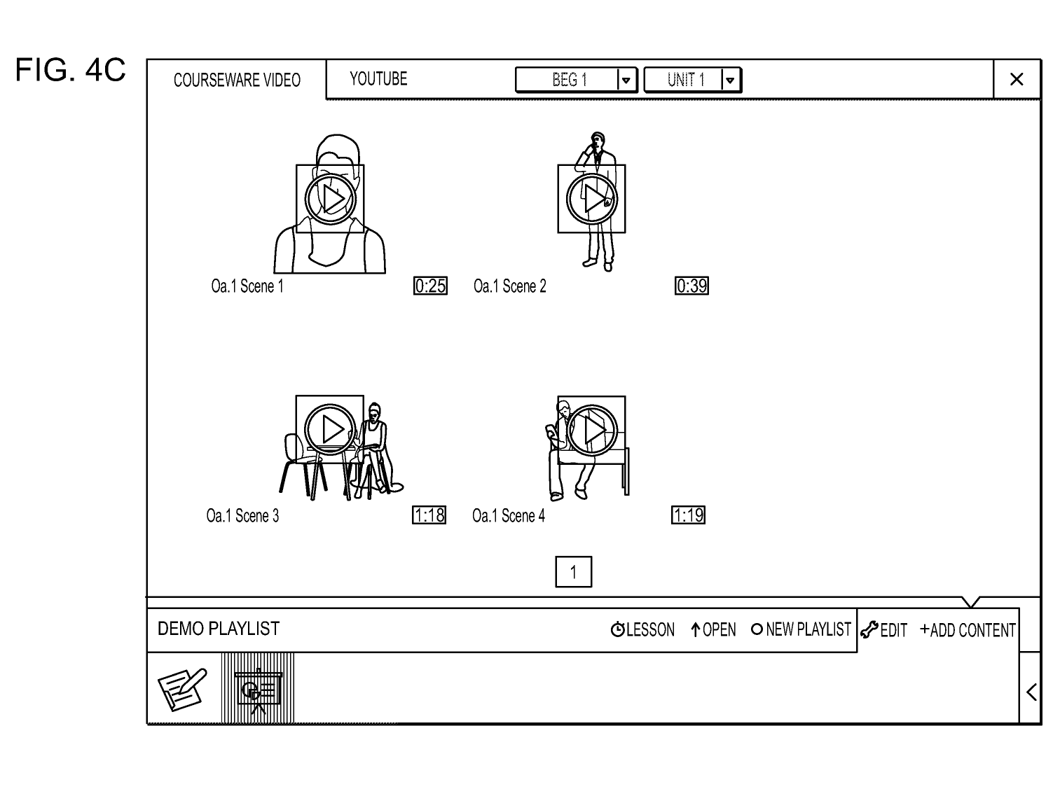

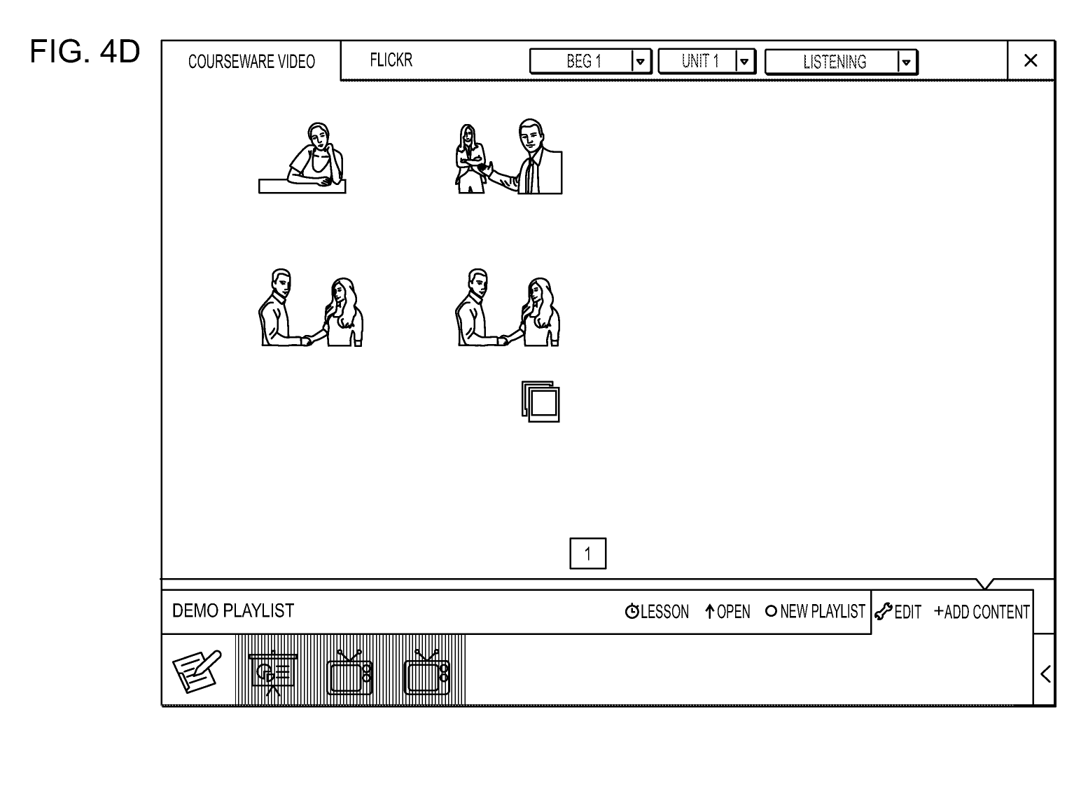

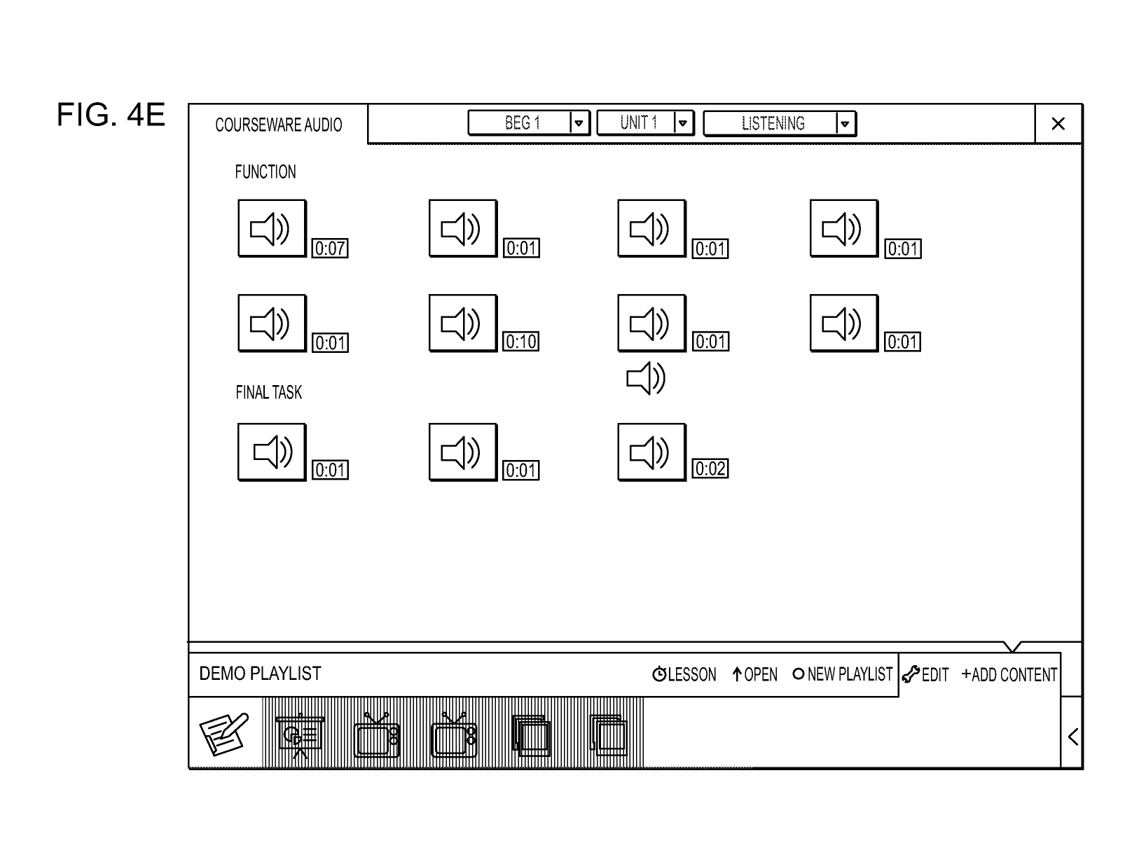

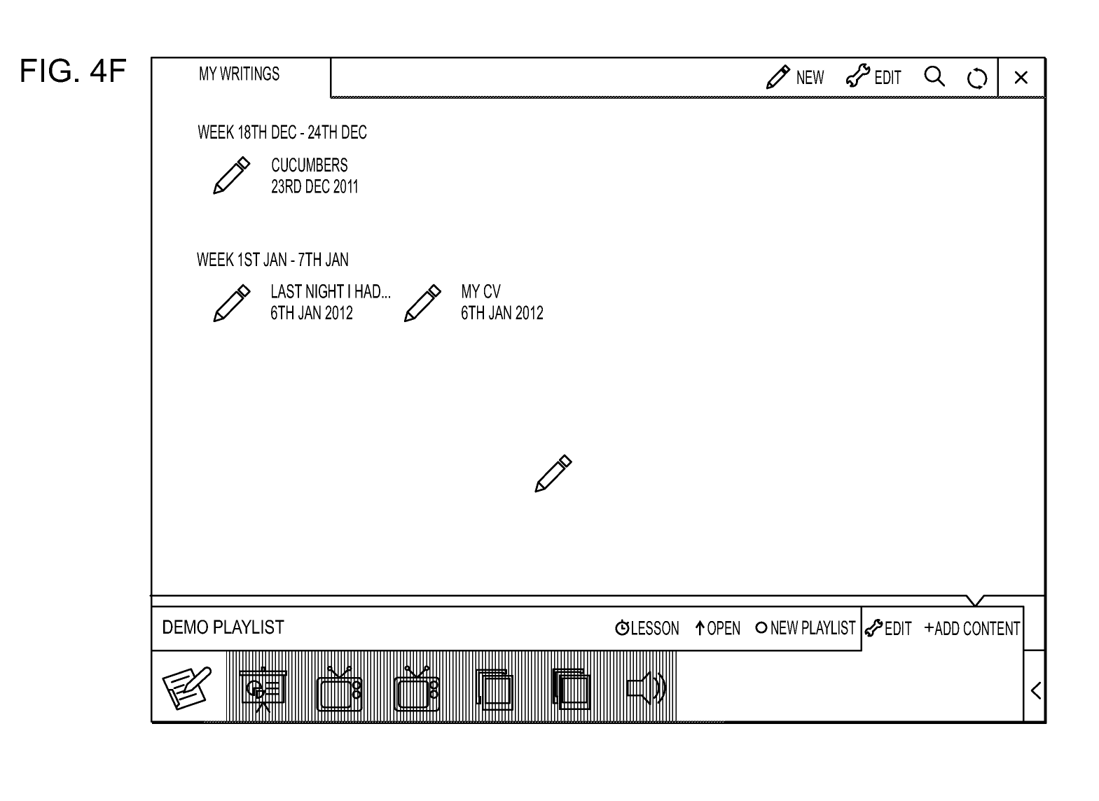

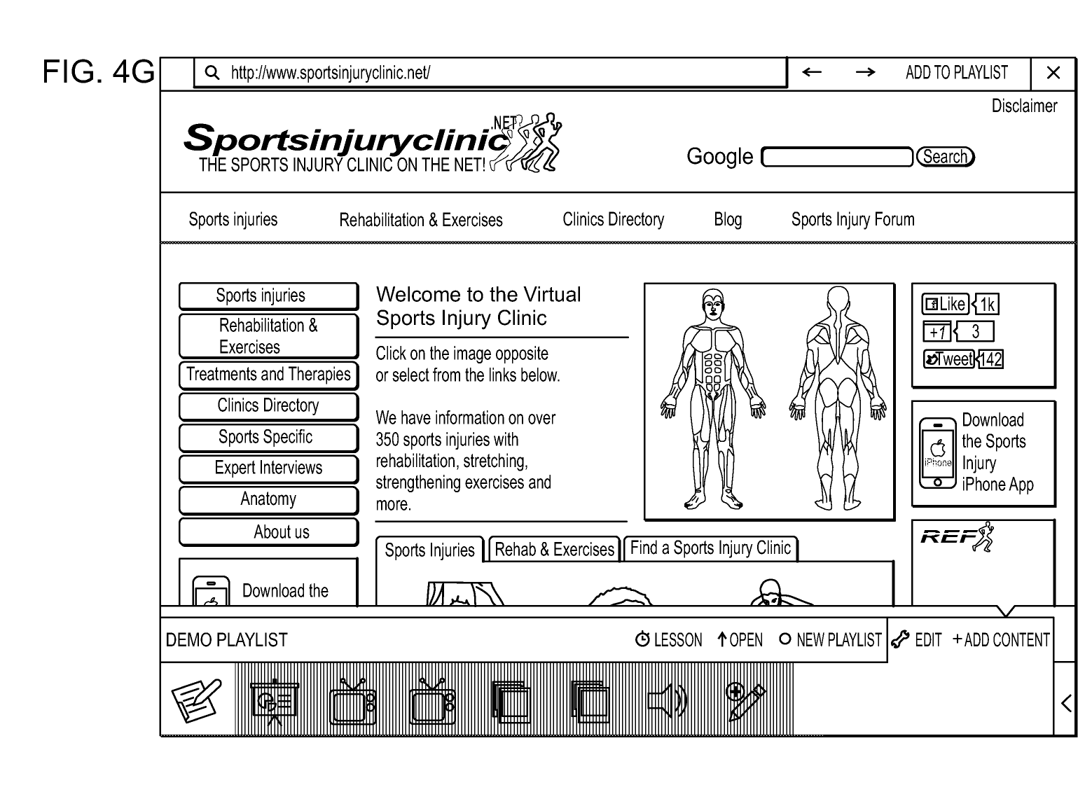

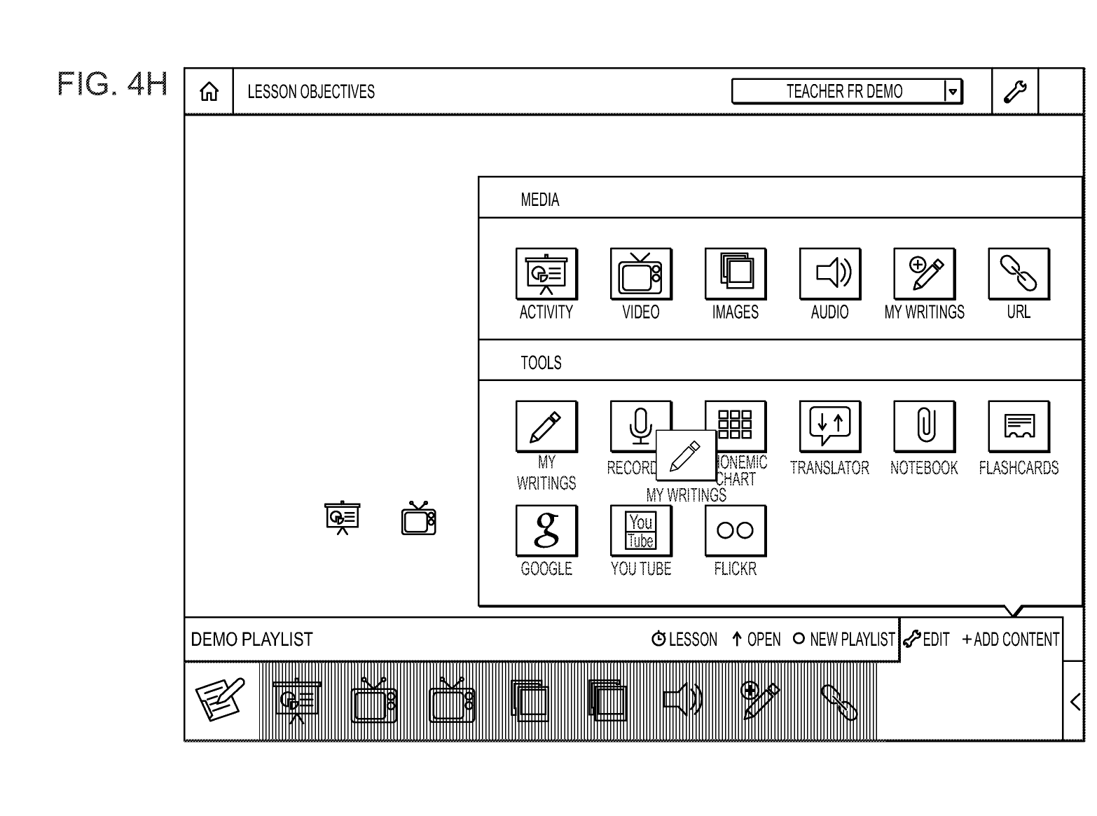

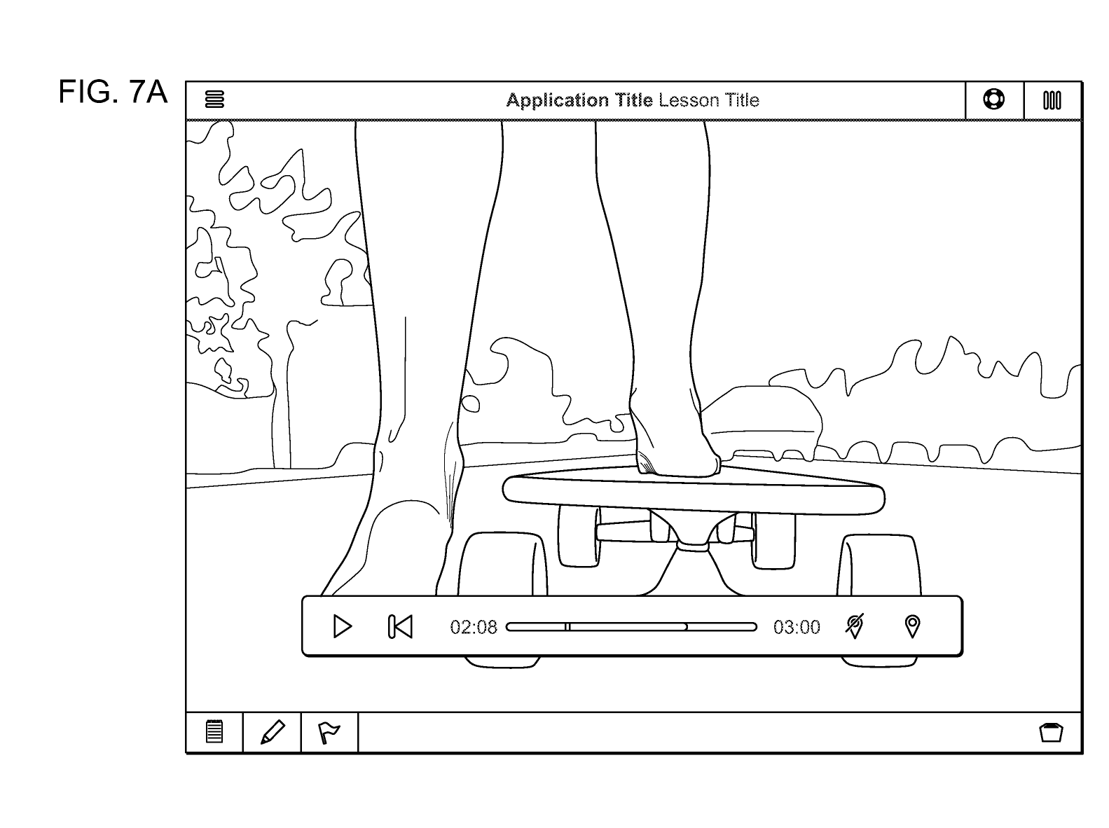

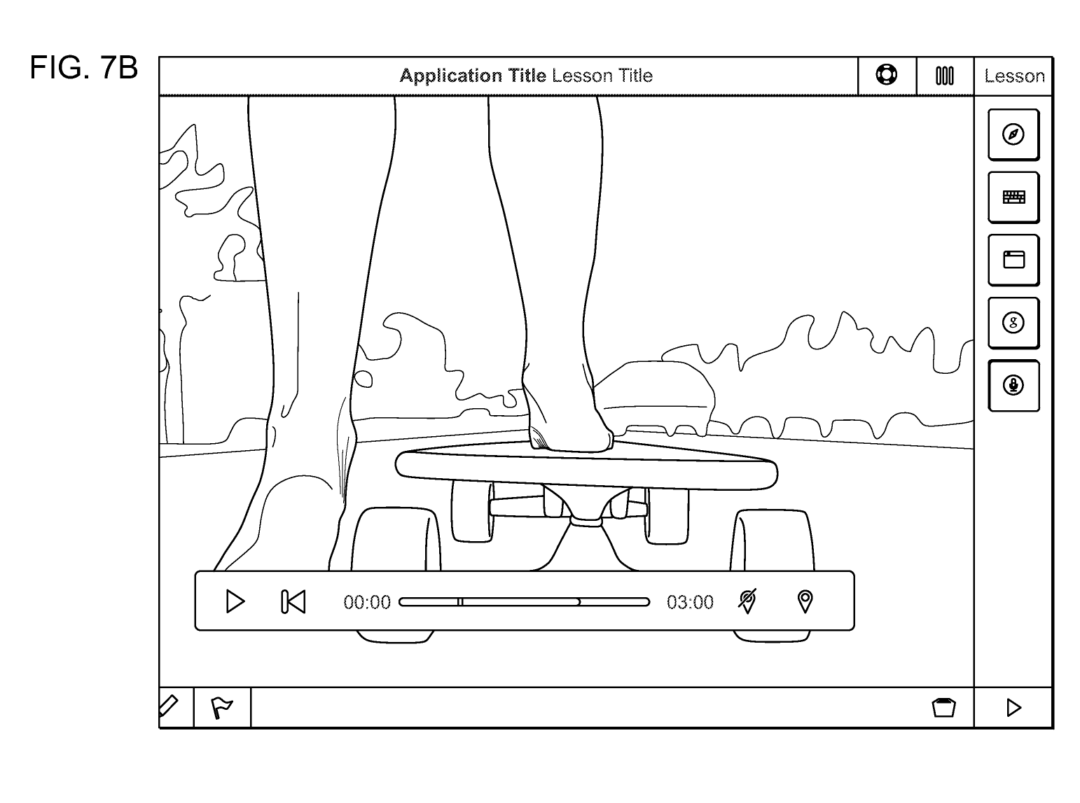

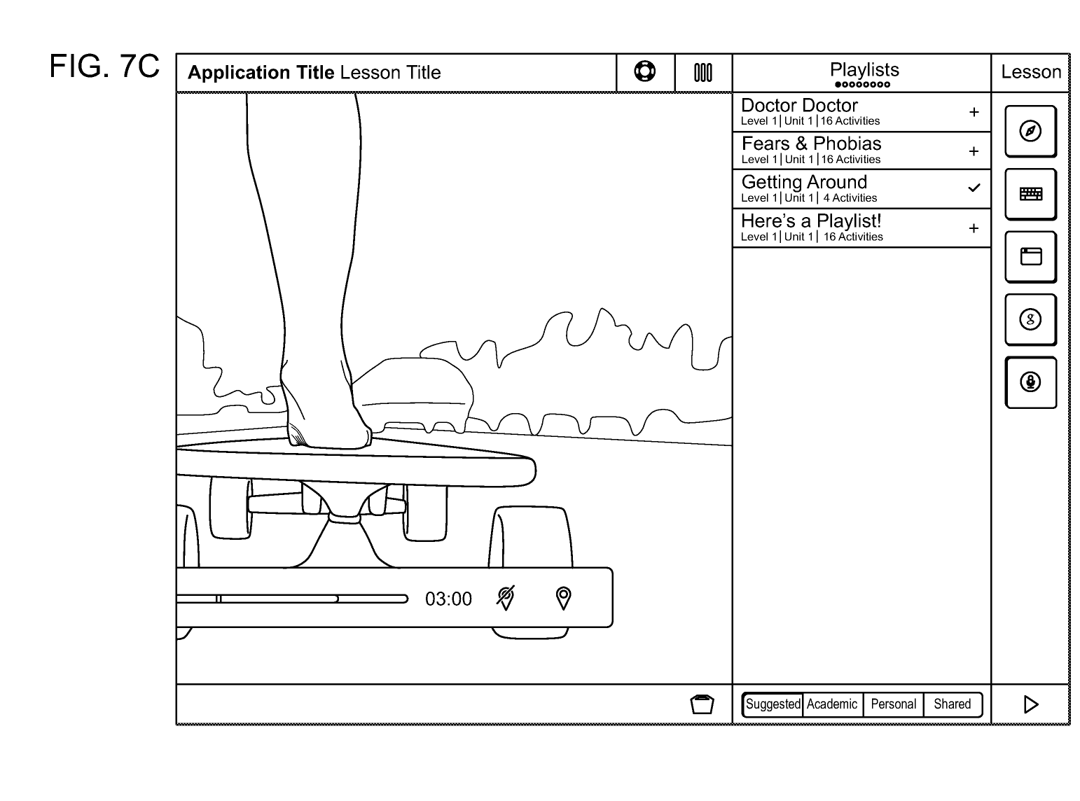

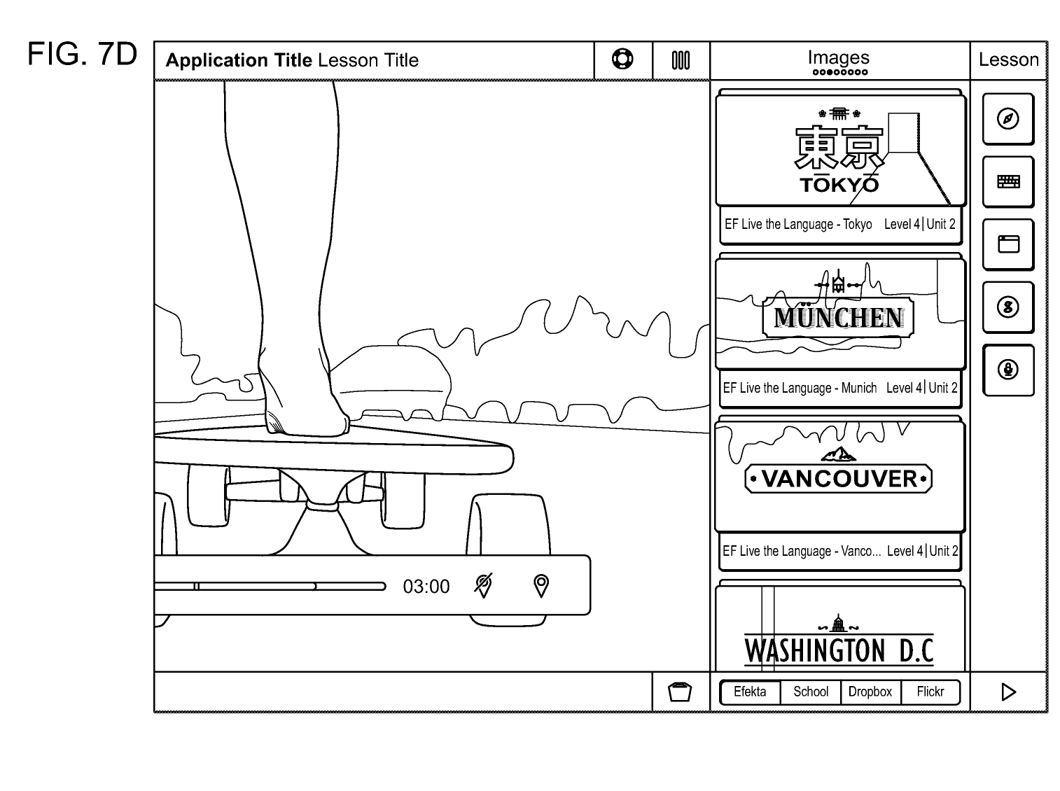

The playlist drawer is the navigation control element used by the teacher during the lesson, and the drawer can be opened and closed at any time by tapping the arrow to the rightmost area of the drawer as shown in the FIGS. 3 and 4A-4H embodiments. Alternately, in the FIG. 7A-7D embodiment, the lesson tray with the learning items is revealed by a finger swipe on the device display from right to left. Other ways of accessing the lesson tray are, of course, also possible.

The playlist gives the lesson structure and a clear chronological order of the lesson, but also offers flexibility to the individual user to view each item at his or her own pace and to revisit already viewed items.

A playlist is a collection of items that are to be used in the lesson. A playlist can have the following parameters and information:
Name
Description
Created Date
Created By
Information for which level and unit the playlist is intended
A sequence of links to playlist items

There are three types of playlists:
My Playlists—created by the user
Model Playlists—created by a central Academic Team
Shared Playlists—created by any teacher and shared with the network of teachers using the learning system.

A playlist can be altered at any stage, giving the teacher great flexibility in the lesson to be responsive to the dynamic of the classroom and the students' varying needs and interests. At any time, the teacher can choose to delete or rearrange not-sent items or add new items. If the teacher alters a Model Playlist or a Shared Playlist that is not his or her own, a copy will automatically be made and saved such that no changes are reflected back on the original version.

Playlists are preferably lightweight and only contain links to the content. As FIG. 4 shows, a playlist can hold a wide variety of content, media, and tools. The system supports continuous addition of new types of content, media, and tools. As playlists generally only hold links to the tools or content, the communication between the teacher's computing device and students' computing devices is kept as lightweight as possible. The format of the playlists is such that it will be readable by any system and is not dependent on the current computing device implementation.

In accordance with one or more embodiments, teachers can bundle content together for a particular learning item. For example, four images may be part of the same learning item where students are to work out a story line using the images. Instead of sending the images separately, the teacher can conveniently send them in one bundle.

In accordance with one or more further embodiments, teachers can create groups of students to distribute playlist items to separate groups. Groups can be created in various ways. For example, a teacher can manually place students into groups. The teacher can also create groups automatically. The teacher selects the number of groups desired, and students are automatically assigned to particular groups.

In another way of creating groups, the teacher specifies different groups (e.g., A, B, C) and sends a screen out to students where each student simply taps on the group they are to join. This allows teachers to quickly set up groups by pointing at students one by one and assigning them to a group. The teacher can also allocate a specific topic to each group and let students choose which group they want to join.

Playlist items can be distributed in various ways. For instance, items can be distributed to all students in the active lesson. Items can also be distributed to specific groups. This allows the teacher to select the specific group or groups that should receive a specified learning item. Teachers can also split bundle content randomly. This allows the content in a bundle to be split in an even and random fashion amongst the existing groups. If no groups exist, the split is per connected device.

Teachers can also split items in a bundle by using categories. For instance, the teacher can create a topic based on the number of items in the bundle, and send out a screen where students can select which topic they want or which they have been assigned by the teacher.

In accordance with one or more embodiments, the system allows a student device to send content/media to other students. The teacher can, during an active lesson, allow another device in the lesson to send content and media to the other devices. The right to distribute content can at any time be revoked by the teacher such that the teacher device is once again the device that send out content and media to the other devices.

In accordance with one or more embodiments, the teacher device can connect to a projector/screen in the classroom to show media/content on a big screen for the entire class to see. In some embodiments, the teacher can also allow for another device in the classroom to connect to the projector/screen to show content/media. The teacher can at any time revoke the right for the student device to project/show to the big screen.

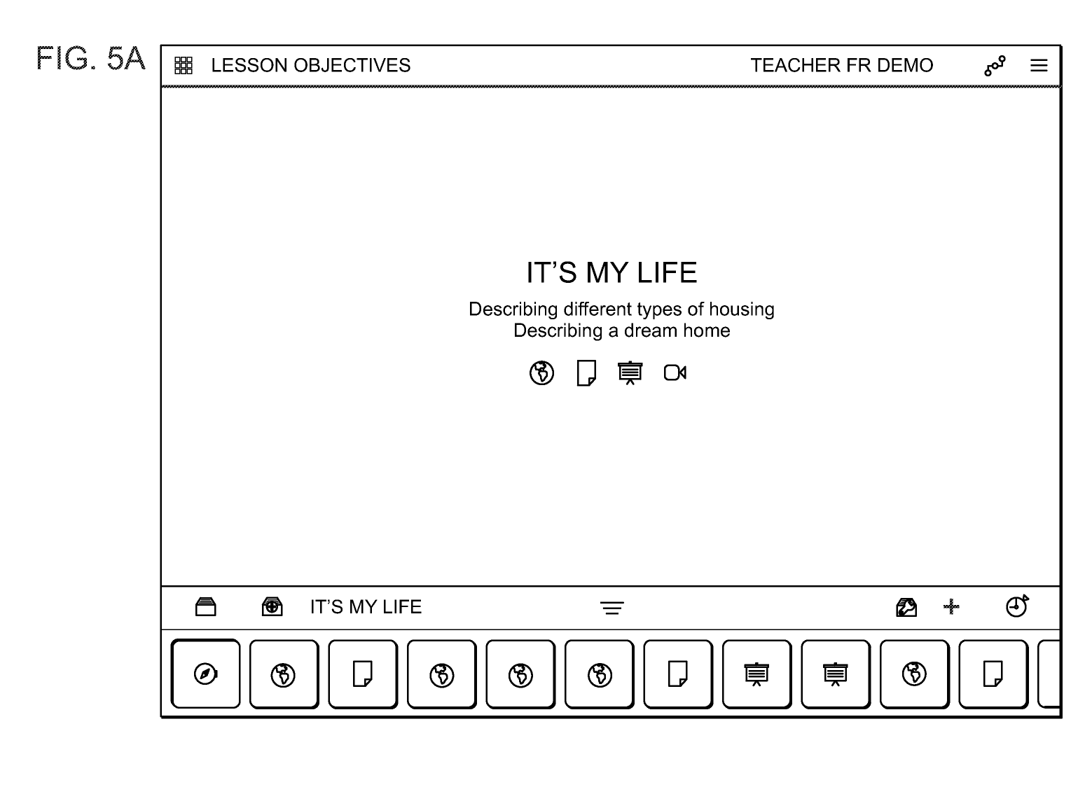

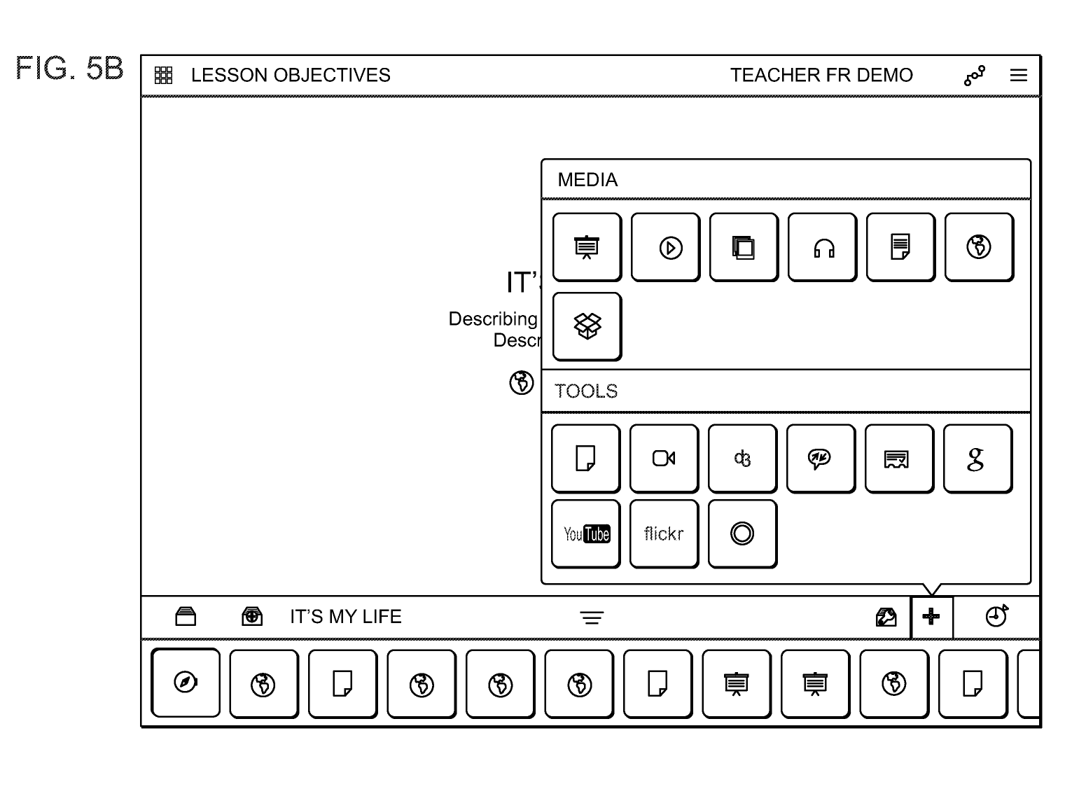

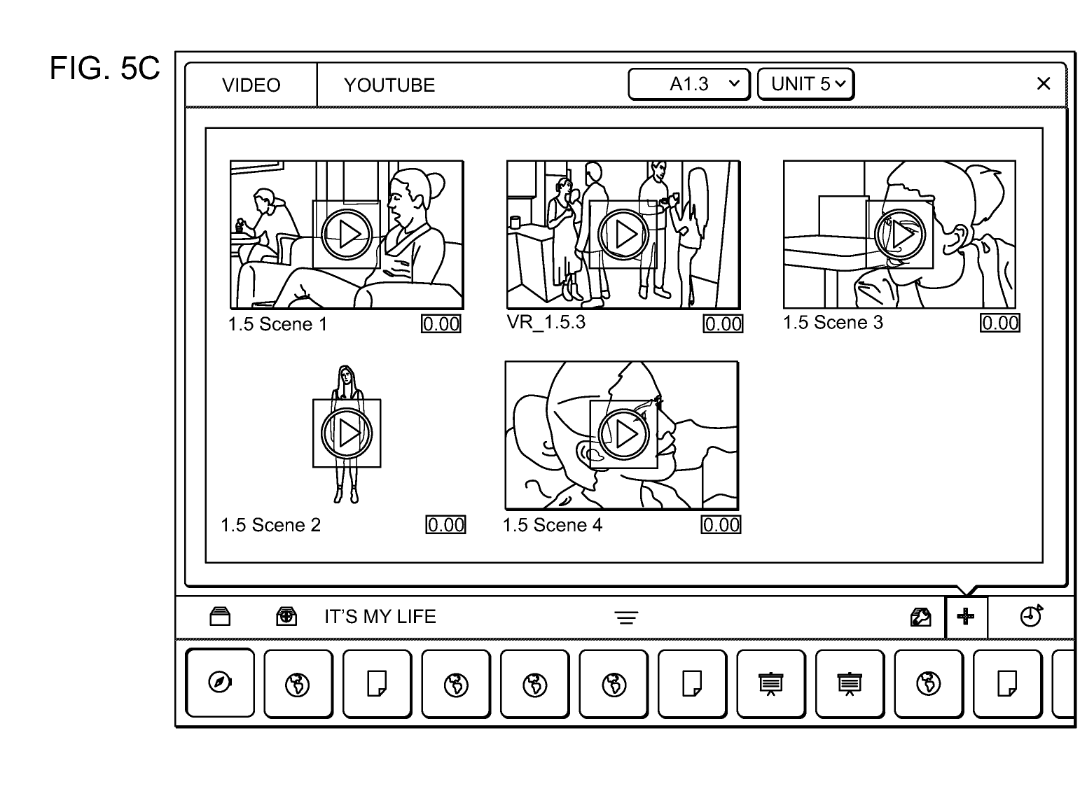

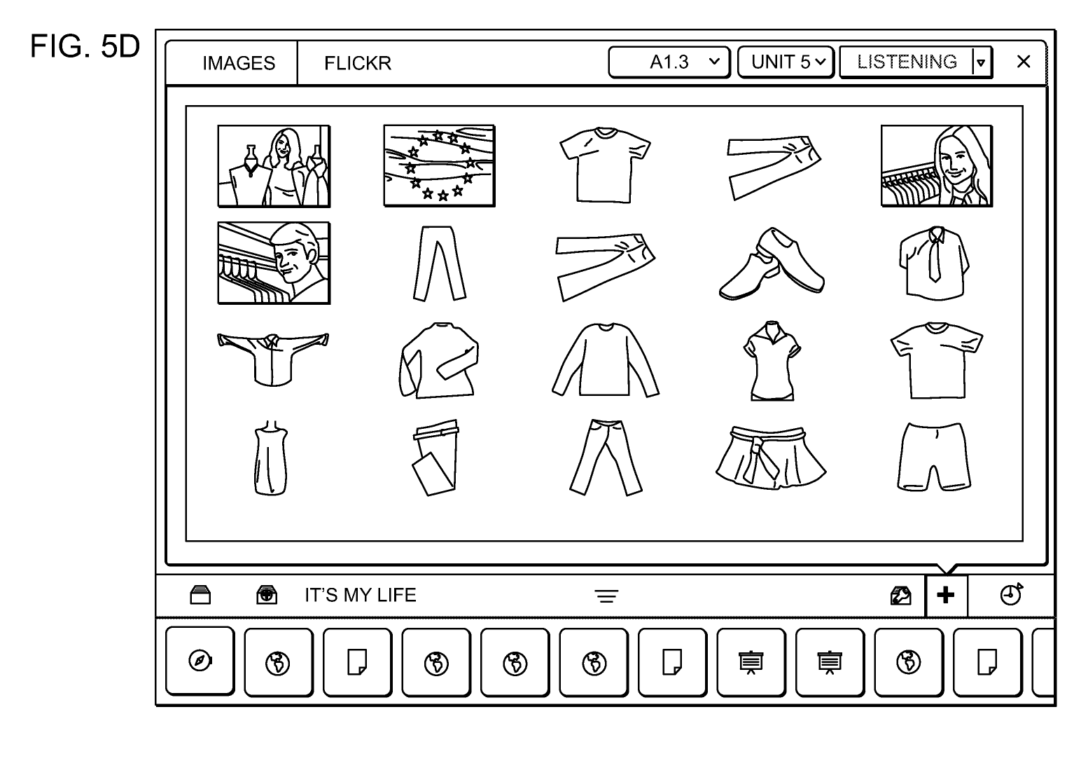

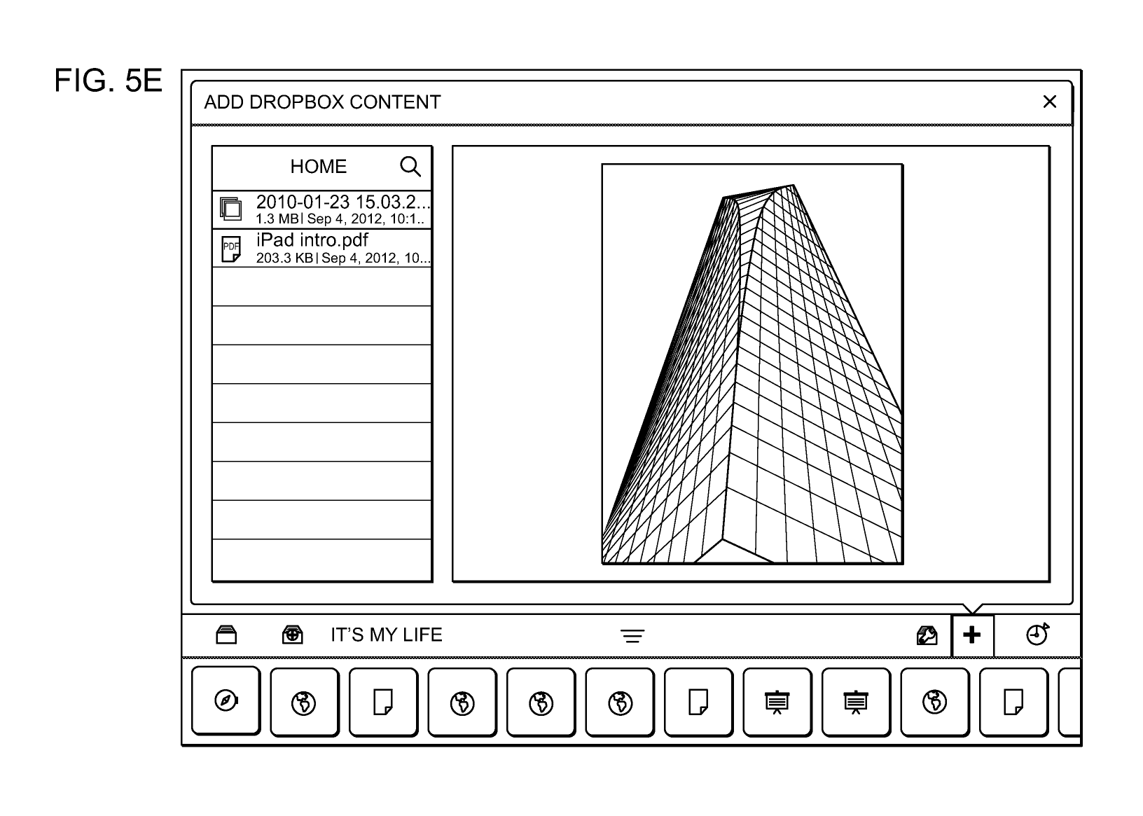

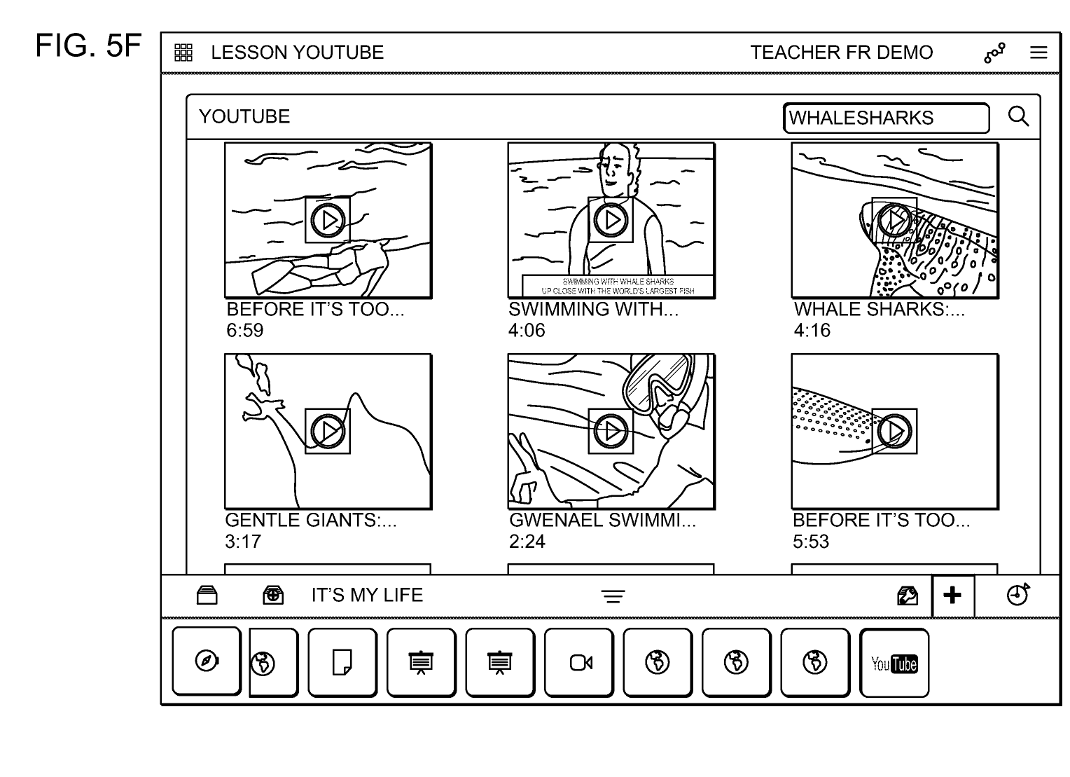

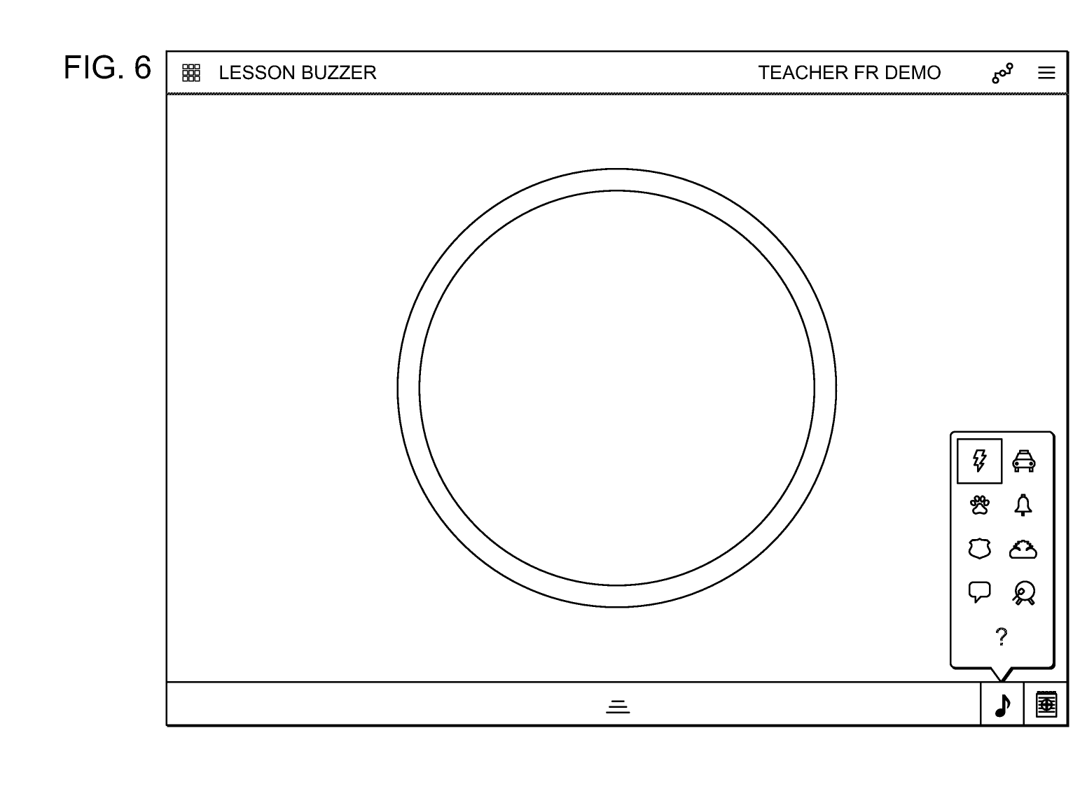

In accordance with one or more embodiments, content from Dropbox or other external content repositories can be added to playlists as illustrated in FIG. 5E. By integrating Dropbox or other external content repositories into the application, external content or content produced by the teacher can be easily added to playlists.

In accordance with one or more embodiments, the teacher can set Alarms, Timers, and Stopwatches for the lesson. Timers can also be shown to students so that the teacher can set a deadline for each learning item sent out.

In accordance with one or more embodiments, teachers can use quiz and activity tools to create quizzes on the fly. As a simple example, the teacher can select two images and set a question and the image that represents the correct answer. The teacher can also take text from any source and turn it into an interactive activity. For example, the teacher can select words in the text to either be hidden from students (so that the students can add them back in) or marked in a non-visible way (so that students can detect and select the words by tapping on them).

A scribble tool is provided in accordance with one or more further embodiments. This tool allows the teacher to scribble on top of any activity content and send the scribble out to students. For example, the teacher can use the tool when he or she wants to highlight parts of an image or spell things out for students. The tool is also available for students to scribble on top of any learning item that they have been sent. For example, students can use predefined diagrams, tables, and charts to scribble on to structure, map, and group their learning.

The processes of the learning system described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions.

Accordingly, the foregoing description and attached drawings are by way of example only, and are not intended to be limiting.

What is claimed is:

1. A computer-implemented method enabling guides to distribute learning items to a plurality of participants in a group learning setting in a controlled manner and to guide the participants through learning activities associated with the learning items, said guides and participants operating network-connected computing devices, the method comprising the steps of:
(a) providing a structured collection of learning items arranged in a given order on a computing device operated by a guide, each learning item being associated with a learning activity to be performed on computing devices operated by the participants; and
(b) electronically distributing learning items in the structured collection to computing devices operated by the participants successively in the given order based on instructions received from the guide.

2. The computer-implemented method of claim 1, wherein the guides comprise teachers, the participants comprise students, and the group learning setting comprises a classroom setting.

3. The computer-implemented method of claim 1, wherein the learning items comprise media content, online links, interactive activities, or tools.

4. The computer-implemented method of claim 1, wherein the structured collection comprises a playlist.

5. The computer-implemented method of claim 1, wherein the method steps are implemented in the computing device operated by the guide, and the learning items are distributed over a local area network.

6. The computer-implemented method of claim 1, wherein the method steps are implemented in the computing device operated by the guide, and the learning items are distributed via a server side messaging system.

7. The computer-implemented method of claim 6, wherein communication between the server system and each of said computing devices occurs over the Internet.

8. The computer-implemented method of claim 1, wherein the computing devices comprise tablet computers, desktop computers, notebook computers, personal digital assistants, smart phones, or smart tables.

9. The computer-implemented method of claim 1, wherein the step of providing a structured collection comprises providing a previously prepared structured collection or enabling the guide to create a new structured collection or edit an existing structured collection.

10. The computer-implemented method of claim 1, further comprising visually indicating what action has been performed on each learning item in the structured collection.

11. The computer-implemented method of claim 1, wherein each learning item in the structured collection includes a hyperlink to content, online links, interactive activities, or tools stored locally on a computing device or remotely.

12. The computer-implemented method of claim 1, further comprising enabling the guide to bundle content elements in a single playlist item.

13. The computer-implemented method of claim 1, further comprising defining groups of participants and electronically distributing learning items separately to each group.

14. The computer-implemented method of claim 13, enabling participants to join a particular group using their computing devices.

15. The computer-implemented method of claim 1, further comprising enabling a computing device operated by a participant to transmit a content item to a computing device operated by another participant.

16. The computer-implemented method of claim 1, further comprising enabling a user of a computing device to project content displayed thereon on a separate screen.

17. The computer-implemented method of claim 1, further comprising enabling the guide to add content from an internal or external content repository to the structured collection.

18. The computer-implemented method of claim 1, wherein learning items can be added to, removed from, or rearranged in the structured collection by the guide in the course of a lesson.

19. A computing device, comprising:
at least one processor;
memory associated with the at least one processor;
a display; and
a program supported in the memory for enabling a guide to distribute learning items to a plurality of participants in a group learning setting in a controlled manner and to guide the participants through learning activities associated with the learning items, the program having a plurality of instructions stored therein which, when executed by the at least one processor, cause the at least one processor to:
(a) provide a structured collection of learning items arranged in a given order based on input from the guide, each learning item being associated with a learning activity to be performed on computing devices operated by the participants; and
(b) electronically distribute learning items in the structured collection to computing devices operated by the participants successively in the given order based on instructions received from the guide.

20. The computing device of claim 19, wherein the guide comprises a teacher, the participants comprise students, and the group learning setting comprises a classroom setting.

21. The computing device of claim 19, wherein the learning items comprise media content, online links, interactive activities, or tools.

22. The computing device of claim 19, wherein the structured collection comprises a playlist.

23. The computing device of claim 19, wherein the learning items are distributed over a local area network.

24. The computing device of claim 19, wherein the learning items are distributed via a server side messaging system.

25. The computing device of claim 24, wherein communication between the server system and each of said computing devices occurs over the Internet.

26. The computing device of claim 19, wherein the computing device comprises a tablet computer, a desktop computer, a notebook computer, a personal digital assistant, a smart phone, or a smart table.

27. The computing device of claim 19, wherein the structured collection comprises a previously prepared structured collection, a new structured collection generated by the guide, or an existing structured collection edited by the guide.

28. The computing device of claim 19, wherein actions performed on a learning item in the structured collection are visually indicated.

29. The computing device of claim 19, wherein each learning item in the structured collection includes a hyperlink to content, online links, interactive activities, or tools stored locally on a computing device or remotely.

30. The computing device of claim 19, wherein the program enables the guide to bundle content elements in a single playlist item.

31. The computing device of claim 19, the program enables the guide to define groups of participants and electronically distribute learning items separately to each group.

32. The computing device of claim 31, wherein the program enables participants to join a particular group using their computing devices.

33. The computing device of claim 19, wherein the program permits a computing device operated by a participant to transmit a content item to a computing device operated by another participant.

34. The computing device of claim 19, wherein the program permits a computing device operated by a participant to project content displayed thereon on a separate screen.

35. The computing device of claim 19, wherein the program enables the guide to add content from an internal or external content repository to the structured collection.

36. The computing device of claim 19, wherein the program enables learning items to be added to, removed from, or rearranged in the structured collection by the guide in the course of a lesson.

37. A computer program product for enabling a guide to distribute learning items to a plurality of participants in a group learning setting in a controlled manner and to guide the participants through learning activities associated with the learning items, the computer program product residing on a non-transitory computer readable medium having a plurality of instructions stored thereon which, when executed by a computer processor, cause that computer processor to:
(a) provide a structured collection of learning items arranged in a given order based on input from the guide, each learning item being associated with a learning activity to be performed on computing devices operated by the participants; and
(b) electronically distribute learning items in the structured collection to computing devices operated by the participants successively in the given order based on instructions received from the guide.

38. The computer program product of claim 37, wherein the guide comprises a teacher, the participants comprise students, and the group learning setting comprises a classroom setting.

39. The computer program product of claim 37, wherein the learning items comprise media content, online links, interactive activities, or tools.

40. The computer program product of claim 37, wherein the structured collection comprises a playlist.

41. The computer program product of claim 37, wherein the learning items are distributed over a local area network.

42. The computer program product of claim 37, wherein the learning items are distributed via a server side messaging system.

43. The computer program product of claim 42, wherein communication between the server system and each of said computing devices occurs over the Internet.

44. The computer program product of claim 37, wherein the computing device comprises a tablet computer, a desktop computer, a notebook computer, a personal digital assistant, a smart phone, or a smart table.

45. The computer program product of claim 37, wherein the structured collection comprises a previously prepared structured collection, a new structured collection generated by the guide, or an existing structured collection edited by the guide.

46. The computer program product of claim 37, wherein actions performed on a learning item in the structured collection are visually indicated.

47. The computer program product of claim 37, wherein each learning item in the structured collection includes a hyperlink to content, online links, interactive activities, or tools stored locally on a computing device or remotely.

48. The computer program product of claim 37, wherein the program enables the guide to bundle content elements in a single playlist item.

49. The computer program product of claim 37, the program enables the guide to define groups of participants and electronically distribute learning items separately to each group.

50. The computer program product of claim 31, wherein the program enables participants to join a particular group using their computing devices.

51. The computer program product of claim 37, wherein the program permits a computing device operated by a participant to transmit a content item to a computing device operated by another participant.

52. The computer program product of claim 37, wherein the program permits a computing device operated by a participant to project content displayed thereon on a separate screen.

53. The computer program product of claim 37, wherein the program enables the guide to add content from an internal or external content repository to the structured collection.

54. The computer program product of claim 37, wherein the program enables learning items to be added to, removed from, or rearranged in the structured collection by the guide in the course of a lesson.
